(19) United States
(12) Patent Application Publication
(10) Pub. No.: US 2009/0146408 A1
(43) Pub. Date: Jun. 11, 2009

(54) Electronic book including transparent film and method for recognizing the same

(76) Inventor: Su Jin Kim, Seoul (KR)

Correspondence Address: THE NATH LAW GROUP, 112 South West Street, Alexandria, VA, 22314, US

(21) Appl. No.: 12/227,830

(22) PCT Filed: Jul. 14, 2006
(86) PCT No.: PCT/KR2006/002773

§ 371 Date: Nov. 28, 2008

(30) Foreign Application Priority Data
Jun. 1, 2006 (KR) 10-2006-0049170

(51) Int. Cl. B42D 15/00

(52) U.S. Cl. 283/67; 283/72

(57) ABSTRACT

Provided is an electronic book comprising a book; a transparent film having printed thereon a coordinate code including a coordinate information according to a position in a page of the book, and a page code for selecting the page to be read; and a recognition device including a scanner for reading the coordinate code and the page code, wherein the recognition device stores a page data including an audio data corresponding to the coordinate information, reads the page code corresponding to the page to be read while the transparent film is placed over the page to be read, reads the coordinate code when disposed at the position within the page of the book, and outputs the audio data corresponding to the page code and the coordinate information included in the coordinate code read by the recognition device.

### TECHNICAL FIELD

The present invention relates to an electronic book, and more particularly, to an electronic book including a transparent film and a method for recognizing the same wherein a page code and a coordinate code printed on a transparent film are used instead of printing a code on an entire page of a book to output a content of the page by an audio or a video.

### BACKGROUND ART

It is difficult to obtain various experiences, informations and knowledges in busy lives of modern people. The importance of an indirect experience and an acquisition of knowledge and information through publications such as a book, a newspaper and an advertisement is increasing. Modem books for the acquisition of knowledge use various instruments or provide an audiovisual information in order to increase an efficiency of learning. Such modern books include an electronic book.

Generally, the electronic book includes an Internet electronic book coded in a portable document format (PDF) provided through the Internet and a computer, and a video electronic book where a specific code is printed on pages of the book. Since the present invention relates to the video electronic book, the electronic book will be referring to the video electronic book hereinafter.

FIG. 1 is a diagram illustrating a conventional electronic book. A description thereof will be given with reference to FIG. 1.

As shown in FIG. 1, the video electronic book includes electronic book 10 having a specific code printed on pages thereof, and a recognition device 20 for reading and processing the specific code from the electronic book 10.

In the electronic book 10, the specific code 1 are printed on the entire pages of the book, and a content of the book is printed on the pages having the specific code printed thereon. The specific code includes a coordinate information on the page. A detailed description of the conventional electronic book is disclosed in Korean Patent No. 1995-0004330 titled “NOVEL PRINTING METHOD AND PRINTED PRODUCT”. Therefore, the detailed description is omitted.

A page code 2 including a page information for identifying the page is printed at one side of the page of the electronic book 10.

The recognition device 20 stores a page data including an audio data or a video data associated with a content of the pages of the electronic book 10,

The recognition device 20 reads the page code 2 printed on the electronic book 10, and reads the page data corresponding to the page code 2. When the specific code 1 at a predetermined position is read from the page associated with the page code 2, the recognition device 20 reads, from the page data associated with the page code 2, the audio data or the video data associated with a coordinate information of the specific code 1, and then outputs the audio data or the video data using a speaker or a liquid crystal display (LCD).

As described above, the conventional electronic book is disadvantageous in that the specific code and the page code should be printed on the entire pages of the book at the time of printing the electronic book, resulting in an increase in a manufacturing cost thereof.

Thus, it is difficult for the electronic book to be popular due to a high price of the electronic book.

### DISCLOSURE OF INVENTION

### Technical Problem

It is an object of the present invention to provide an electronic book including a transparent film and a method for recognizing the same wherein a page code and a coordinate code printed on a transparent film are used instead of printing a code on an entire page of a book in order to allow outputting a content of the page by an audio and/or a video.

### Technical Solution

To achieve the above-described objects of the present invention, there is provided an electronic book comprising: a book; a transparent film having printed thereon a coordinate code including a coordinate information according to a position in a page of the book, and a page code for selecting the page to be read; and a recognition device including a scanner for reading the coordinate code and the page code, wherein the recognition device stores a page data including an audio data corresponding to the coordinate information, reads the page code corresponding to the page to be read while the transparent film is placed over the page to be read, reads the coordinate code when disposed at the position within the page of the book, and outputs the audio data corresponding to the page code and the coordinate information included in the coordinate code read by the recognition device.

There is also provided a method for recognizing an electronic book, the electronic book comprising a book; a transparent film having printed thereon a coordinate code and a page code for selecting a page of the book, the coordinate code including a coordinate information according to a position within the transparent film; and a recognition device including a scanner for reading the coordinate code and the page code and storing a page data including an audio data corresponding to the coordinate information, the method comprising steps of: (a) outputting a page input request message through the recognition device when a reading signal is inputted by a user; (b) reading the page code of the page to be read through the recognition device; (c) reading the coordinate code of the page to be read through the recognition device; and (d) outputting the audio data corresponding to the page code and the coordinate information read in the steps (b) and (c).

### Advantageous Effects

As described above, the present invention is advantageous in that audio and/or video information may be provided by using the transparent film having the page code and the coordinate code printed thereon without printing the specific code on the entire pages of the book. Therefore, a manufacturing cost of the book may be reduced. Further, the book may be provided at a lower price.

### BRIEF DESCRIPTION OF THE DRAWINGS

FIG. 1 is a diagram illustrating a conventional electronic book.

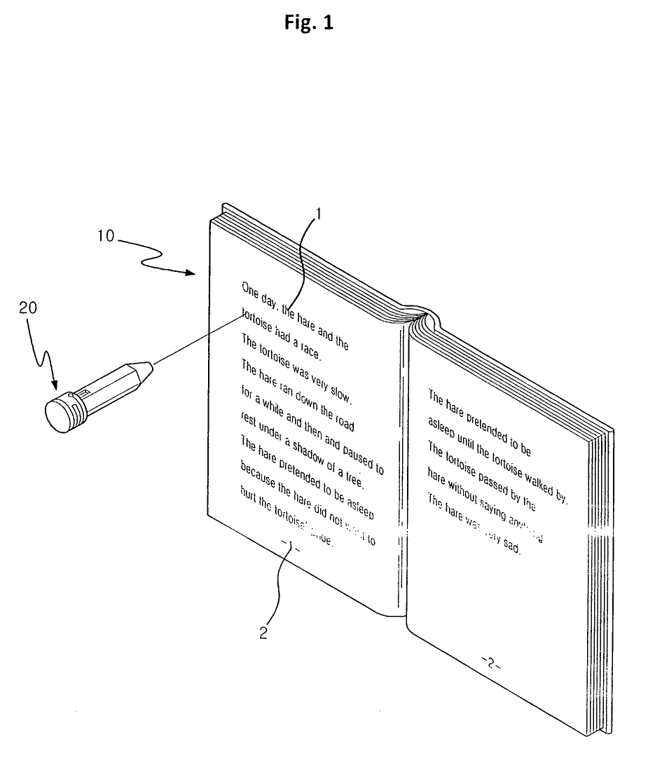

FIG. 2a is a diagram illustrating an electronic book including a transparent film in accordance with a first embodiment of the present invention.

FIG. 2b is a diagram illustrating a structure wherein the transparent film is inserted into a book according to the first embodiment of the present invention.

FIG. 3 is a diagram illustrating an electronic book including a transparent film in accordance with a second embodiment of the present invention.

FIG. 4 is a block diagram schematically illustrating a recognition device shown in FIGS. 2a, 2b and 3.

FIG. 5 is a flow diagram illustrating a method for recognizing an electronic book including a transparent film in accordance with the first embodiment of the present invention.

### BEST MODE FOR CARRYING OUT THE INVENTION

Hereinafter, preferred embodiments of the present invention will be described in detail with reference to accompanying drawings.

An electronic book in accordance with the present invention comprises a book; a transparent film of one sheet or two sheets having an end portion bonded to each other wherein the transparent film has a coordinate code including a coordinate information and a page code including a page information (hereinafter, a code including both the coordinate code and the page code is referred to as “specific code”) printed thereon; and a recognition device including a scanner for reading the coordinate code and the page code. The recognition device stores a page data including an audio data and/or a video data matching the coordinate information corresponding to a content of the page, reads the page code corresponding to the page while the transparent film is placed over the page to be recognized, reads the coordinate code when disposed at the position within the transparent film, and outputs the audio data and/or the video data corresponding to the coordinate information included in the coordinate code read by the recognition device.

The book may include a normal book, a pamphlet, a menu, a newspaper and an advertisement board. A single sheet of the transparent film may be used to recognize the normal book, the pamphlet, the menu, and the newspaper. However, it is preferable that two transparent films having their end portions bonded together are used in order to facilitate aligning of the coordinate code printed on the transparent film with the content of the book. It s also preferable that the single sheet of the transparent film is used for the advertisement board.

The page code is printed in a region of the transparent film that does not overlap with a content of the book. The page code may include page numbers associated with an entirety of the pages of the book or include numbers ranging from 0 to 9. In the latter case, the page number in order to select the page may be carried out by entering a combination of the page codes ranging from 0 to 9. For instance, when page 12 is to be selected, the number 1 and the number 2 of the page code printed on the transparent film should be scanned using the recognition device. The recognition device combines the scanned page code and then loads the page data corresponding to the page 12. A user should use the recognition device to scan the numbers 1 and 2 of the page code by pressing “combination button” of the recognition device.

The electronic book and a method for recognizing the same are hereinafter described in detail with reference to the accompanying drawings.

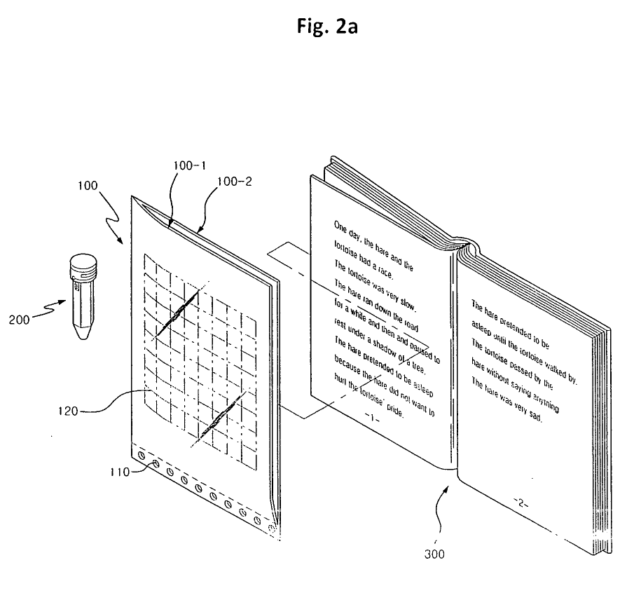

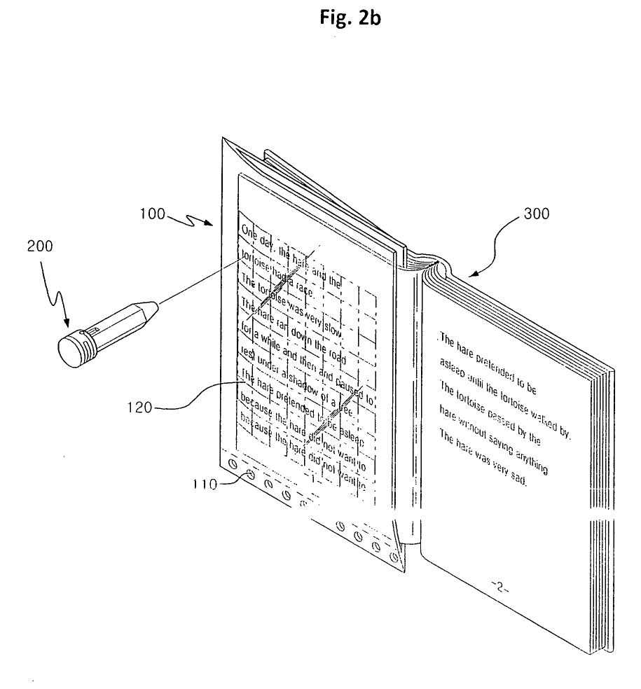

FIG. 2a is a diagram illustrating an electronic book including a transparent film in accordance with a first embodiment of the present invention, and FIG. 2b is a diagram illustrating a structure wherein the transparent film is inserted into a book according to the first embodiment of the present invention.

The electronic book in accordance with the first embodiment of the present invention includes a book 300 without any specific code printed thereon, a transparent film 100 a transparent folder type having the specific code printed on an outer surface of the transparent film, and a pencil type recognition device 200.

The transparent film 100 shown in FIGS. 2a and 2b has a size corresponding to that of the book 300 and comprises a transparent film 100-1 and a transparent film 100-2. End portions of the transparent film 100-1 and the transparent film 100-2 are bonded inward such that the transparent film 100 covers the page of the book 300 as shown in FIG. 2b. That is, the transparent film 100 has a form of transparent folder (or file). The specific code is printed on the outer surface of the transparent film 100-1 and the transparent film 100-2. The transparent film 100 includes a first region 110 wherein the page code of the specific code is printed and a second region 120 wherein the coordinate code of the specific code is printed. FIG. 2A depicts the page code ranging from 0 to 9 printed in the first region 110. Tenth or latter pages may be selected by combining the page codes ranging from 0 to 9. In addition, the page code corresponding to the entirety of pages may be printed in the first region 110. However, when the book has a large number of pages, the printing of the page code may be limited. Therefore, the latter may be applied to the book for infants or children having a small number of pages and the former employing the combination method may be applied to books having the large number of pages. While FIGS. 2a and 2b illustrate the first region wherein the page code are printed located at a lower portion, the first region may be located at an upper portion, a left side or a right side. However, the content of the book 300 and the first region 110 should not overlap with each other.

While the pencil type recognition device 200 is shown in FIGS. 2a and 2b, the recognition device 200 may be integrated into an MP3 player, a PDA, and a mobile phone.

### MODE FOR INVENTION

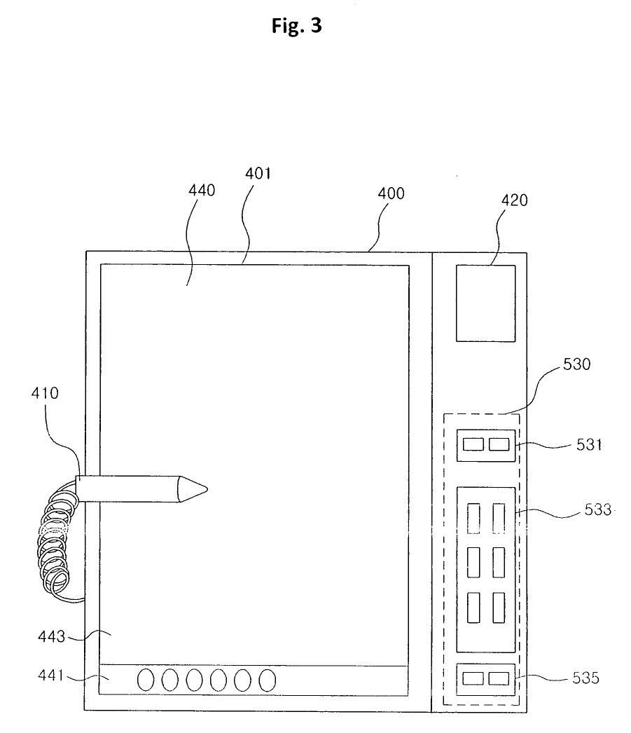

FIG. 3 is a diagram illustrating an electronic book including a transparent film in accordance with a second embodiment of the present invention wherein the present invention is applied to an advertisement board.

Reference numeral 400 denotes a recognition device for the advertisement board.

Referring to FIG. 3, the recognition device 400 for the advertisement board includes a scanner 410, a speaker 420, an input device 530, and a frame 401 for inserting a transparent film 440 having a specific code printed thereon.

An advertisement sheet (not shown) having a plurality of advertisements may be placed under the transparent film 440. An advertisement belt having the plurality of advertisements may be disposed under the transparent film 440 and the advertisement belt may be rotated by a roller (not shown) to sequentially show the plurality of advertisements through the frame.

The input device 530 may include a volume controller 531 for controlling a volume of an advertisement announcement, a language selector 533 for selecting a language, and an advertisement selector 535 for selecting the advertisement.

The scanner 410 reads the specific code printed on the transparent film 440 inserted into the frame 401.

Similar to the transparent film shown in FIGS. 2a and 2b, the transparent film 440 inserted into the advertisement board may include a second region 443 wherein a coordinate code is printed and a first region 441 wherein a page code is printed. In addition, the advertisement sheet disposed under the transparent film 440 may be selected using the advertisement selecting unit 535 of the input device 530.

While FIG. 3 depicts the specific code printed on the transparent film 440, the specific code may be printed on each of the plurality of advertisements.

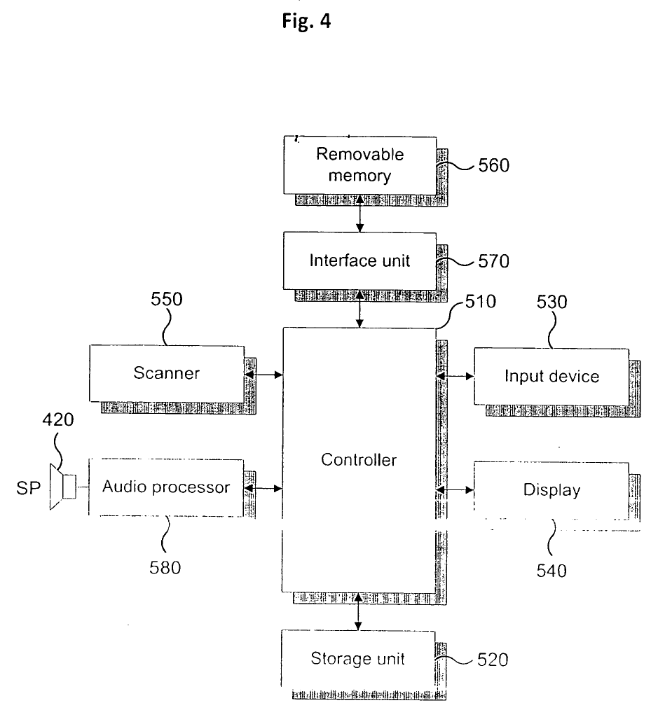

A constitution and an operation of the recognition device will now be described with reference to FIG. 4.

FIG. 4 is a block diagram schematically illustrating a recognition device shown in FIGS. 2a, 2b and 3.

Referring to FIG. 4, the recognition device in accordance with the present invention includes a controller 510, a storage unit 520, the input device 530, a display 540, a scanner 550, a removable memory 560, an interface unit 570, an audio processor 580, and the speaker 420.

The controller 510 controls a general operation of the recognition device in accordance with the present invention. Particularly, the controller 510 receives the page code and the coordinate code, loads the audio data and/or the video data corresponding to the received page code and coordinate code, and outputs the audio data and/or video data through the audio processor 580 and the display unit 540.

The storage unit 520 includes a region for storing a control program for controlling the operation of the recognition device, and a region for temporarily storing data generated during an execution of the control program.

In accordance with the first embodiment of the present invention shown in FIGS. 2a and 2b, the input device 530 includes a plurality of buttons for the user to control the recognition device such as a power button (or power switch), a volume button, a page combination button, and a read button for initiating the reading of the coordinate code. In accordance with the second embodiment of the present invention shown in FIG. 3, the input device 530 includes buttons for the volume controller 531, the language selector 533 and the advertisement selector 535. Electrical signals corresponding to the buttons that is pressed is transmitted to the controller 510.

The display 540, although not shown in FIGS. 2a, 2b and 3, displays texts, graphics or videos according to a control signal of the controller 510.

The scanner 550 reads or scans the specific code printed on the transparent film, and outputs the read specific code to the controller 510.

The removable memory 560, which may include a flash memory, stores the page data including the audio data and/or the video data corresponding to the coordinate code of the page or the advertisement. The removable memory 560 may be detached from the recognition device. The removable memory 560 can be provided along with the book or the advertisement. Alternately, the removable memory 560 may receive and store the page data associated with the book and the advertisement through a computer. The removable memory 560 may be one of a SD (security digital) card, a CF (compact flash) card and a USB (universal serial but) memory.

The interface unit 570 includes a connector for connecting to the removable memory 560, and performs a data communication between the removable memory 560 and the controller 510.

The audio processor 580 includes the speaker 420, and outputs the audio data according to the control signal of the controller 510.

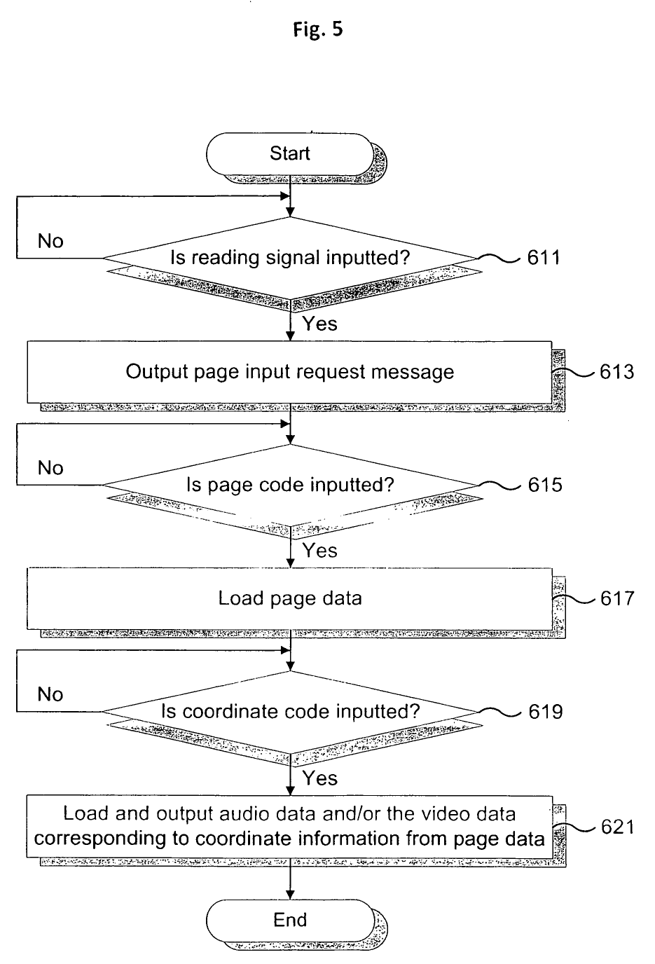

FIG. 5 is a flow diagram illustrating a method for recognizing an electronic book including a transparent film in accordance with the first embodiment of the present invention. The method will be described with reference to FIGS. 4 and 5.

In the step 611, the controller 510 determines if a reading signal for the specific code is inputted. The reading signal is generated pressing the power switch or a “read” button.

When the reading signal is inputted in the step 611, the controller 510 of the recognition device outputs a page input request message which may be a voice message “Please select a page” through the audio processor 580 and the speaker 420 in the step 613.

After outputting the page input request message in the step 613, the controller 510 checks if the page code is inputted through the scanner 550 in the step 615. The controller 510 may receive a plurality of the page code and determine the page by combining the plurality of page code.

When the page code is inputted in the step 615, the controller 510 reads the page data corresponding to the page code for the page to be read from the removable memory 560 through the interface unit 570 of the recognition device to be stored in the storage unit 520 in the step 617.

After storing the page data in the storage unit 520 in the step 617, the controller 510 determines whether the coordinate code is inputted through the scanner 550 in the step 619.

When the coordinate code is determined to be inputted in the step 619, the controller 510 reads the page data stored in storage unit 520 including the audio data and/or the video data corresponding to the coordinate information of the coordinate code. The controller 510 then outputs the audio data and/or the video data through the audio processor 580 and/or the display 540 in the step 621.

In accordance with the embodiment shown in FIG. 5, the controller 510 stores the page data in the storage unit 520 when the page code is inputted and reads the page data including the audio data and/or the video data from the storage unit 520 when the coordinate code is inputted. However, the controller 510 may read the page data including the audio data and/or the video data corresponding to the coordinate information of the page from the removable memory 560 to be outputted through the audio processor 580 and/or the display 540.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

As described above, the present invention is advantageous in that audio and/or video information may be provided by using the transparent film having the page code and the coordinate code printed thereon without printing the page code and the coordinate code on the entire pages of the book. Therefore, a manufacturing cost of the book may be reduced. Further, the book may be provided at a lower price.

1. An electronic book comprising:
a book;
a transparent film having printed thereon a coordinate code including a coordinate information according to a position in a page of the book, and a page code for selecting the page to be read; and
a recognition device including a scanner for reading the coordinate code and the page code,
wherein the recognition device stores a page data including an audio data corresponding to the coordinate information, reads the page code corresponding to the page to be read while the transparent film is placed over the page to be read, reads the coordinate code when disposed at the position within the page of the book, and outputs the audio data corresponding to the page code and the coordinate information included in the coordinate code read by the recognition device.

2. The electronic book in accordance with claim 1, wherein the page code includes a page value associated with the page of the book.

3. The electronic book in accordance with claim 1, wherein the page code ranges from 0 to 9.

4. The electronic book in accordance with claim 3, wherein the recognition device recognizes ten or more pages of the books by a combination of the page codes of 0 to 9.

5. The electronic book in accordance with claim 1, wherein the transparent film is of a transparent folder type, the page code and the coordinate code being printed on an outer surface of the transparent film.

6. The electronic book in accordance with claim 1, wherein the page data further includes a video data matching the coordinate information, the video data being outputted along with the audio data

7. A method for recognizing an electronic book, the electronic book comprising a book; a transparent film having printed thereon a coordinate code and a page code for selecting a page of the book, the coordinate code including a coordinate information according to a position within the transparent film; and a recognition device including a scanner for reading the coordinate code and the page code and storing a page data including an audio data corresponding to the coordinate information, the method comprising steps of:
(a) outputting a page input request message through the recognition device when a reading signal is inputted by a user;
(b) reading the page code of the page to be read through the recognition device;
(c) reading the coordinate code of the page to be read through the recognition device; and
(d) outputting the audio data corresponding to the page code and the coordinate information read in the steps (b) and (c).

8. The method in accordance with claim 7, wherein the page code ranges from 0 to 9.

9. The method in accordance with claim 8, wherein the book includes ten or more pages, and the step (b) includes recognizing the page by combining the page code ranging from 0 to 9 for the page later than a tenth page.
